(19) United States
(12) Patent Application Publication
(10) Pub. No.: US 2003/0184859 A1
(43) Pub. Date: Oct. 2, 2003

(54) Auxiliary binocular device for astronomical telescope

(76) Inventors: Guang-Qu Liang, Guangzhou (CN); Zhou-Ying Chen, Guangzhou (CN); Mao Li, Guangzhou (CN)

Correspondence Address: Liberty Patent and Trademark Office, WO, P.O. BOX 590, Taichung City, 400, TW

(21) Appl. No.: 10/309,898

(22) Filed: Dec. 5, 2002

(30) Foreign Application Priority Data
Mar. 29, 2002 (WO) PCT/CN02/00215

(51) Int. Cl. G02B 23/00

(52) U.S. Cl. 359/407; 359/399; 359/409; 359/431

(57) ABSTRACT

An auxiliary binocular device for astronomical telescope, comprising a center tube, a left lens unit, a right lens unit and a beam splitter and image-inverting device, the objective lens of the binocular device being joined to the eyepiece of astronomical telescope, so the telescope becomes binocular. The beam splitter and image-inverting device is installed inside the center tube, the right lens unit and the left lens unit, comprising a beam splitter prism, three reflected mirrors and two lens sets, having beam splitting and image-inverting functions. Thereby, without changing the original structure of the telescope, a binocular device is attached between the front focal surface of the eyepiece of the original telescope and the rear focal surface of the objective lens, to invert and split the image which observed from the astronomical telescope to binocular device, this satisfies people's demand of changing a telescope into a binocular observation instrument, also it can also be used for the observation of earth ground, thereby expanding the range of applications of the original product.

### BACKGROUND OF THE INVENTION

(a) Field of the Invention

The invention relates to an auxiliary binocular device, which the device can be attached to an astronomical telescope or other types of telescopes and observation instruments.

(b) Description of the Prior Art

Conventional astronomical telescope is made in a single tube with an eyepiece from where the viewer peered using one eye . Such observation does not go with habitual observation by ordinary people using their both eyes to see things, who may feel strain and fatigue after using it for a period of time.

### SUMMARY OF THE INVENTION

The primary objective of the invention is to provide an auxiliary binocular device that the device can be attached to a conventional astronomical telescope, providing more comfortable observation than a telescope for viewer.

The second objective of the invention is to provide an auxiliary binocular device that cab be attached to an astronomical telescope, having beam splitting and image-inverting functions.

The third objective of the invention is to provide an auxiliary binocular device that can be attached to an astronomical telescope or other types of instruments for earth ground observation, thereby expanding the area of applications.

### BRIEF DESCRIPTION OF THE INVENTION

The auxiliary binocular device disclosed in present invention comprises a center tube, a left lens unit, a right lens unit and an beam splitter and image-inverting device. Wherein, the center tube is shaped as a tube, having a front end serving as a joint to an astronomical telescope. The left and right lens units are shaped also as tube, both axially parallel to the center tube, sideways projected hinges that are joined to the center tube, and at the ends where for viewer's observation are quipped with eyepieces. The beam splitter and image-inverting device consists of a beam splitter prism, three reflected mirrors and two lens sets. The beam splitter prism and one flat reflected mirror are installed in the center tube, another flat reflected mirror installed axially to the light beam which passing through the beam splitter prism, and the other flat reflected mirror and a lens set are installed sequentially in the right lens unit, and both located axially to a split light beam from the beam splitter prism. Thereby, the beam splitter prism and one flat reflected mirror and one lens set form an image unit and fixed by screw in the right lens unit with one support, meanwhile the other same combination with the right lens unit is installed in the left lens unit. The lens set of the left and right lens units are installed between the two reflected mirrors respectively.

Said structure of the auxiliary binocular device can be attached to an astronomical telescope without changing the original structure of the telescope. The binocular device is installed between the front focal surface and the rear focal surface of the objective lens of the original telescope. When in observation with the combination of the auxiliary binocular device and telescope, the image from the telescope is first inverted by the lens sets of the auxiliary binocular device, then the light beam of the image split by the beam splitter prism , and changed the direction of light by reflected mirror to the right and left eyepieces in the device, the device will satisfy the viewer to have binoculars on an astronomical telescope for observation. The present invention can also be applied to a virtual focal surface eyepiece system of an astronomical telescope.

### BRIEF DESCRIPTION OF DRAWINGS

FIG. 1 is a schematic view of a first embodiment of the invention.

FIG. 2 is a plan view of optical theory in the first embodiment of the invention.

FIG. 3 is a plan view of optical reflections in the second embodiment of the invention.

### DETAILED DESCRIPTION OF PREFERRED EMBODIMENTS

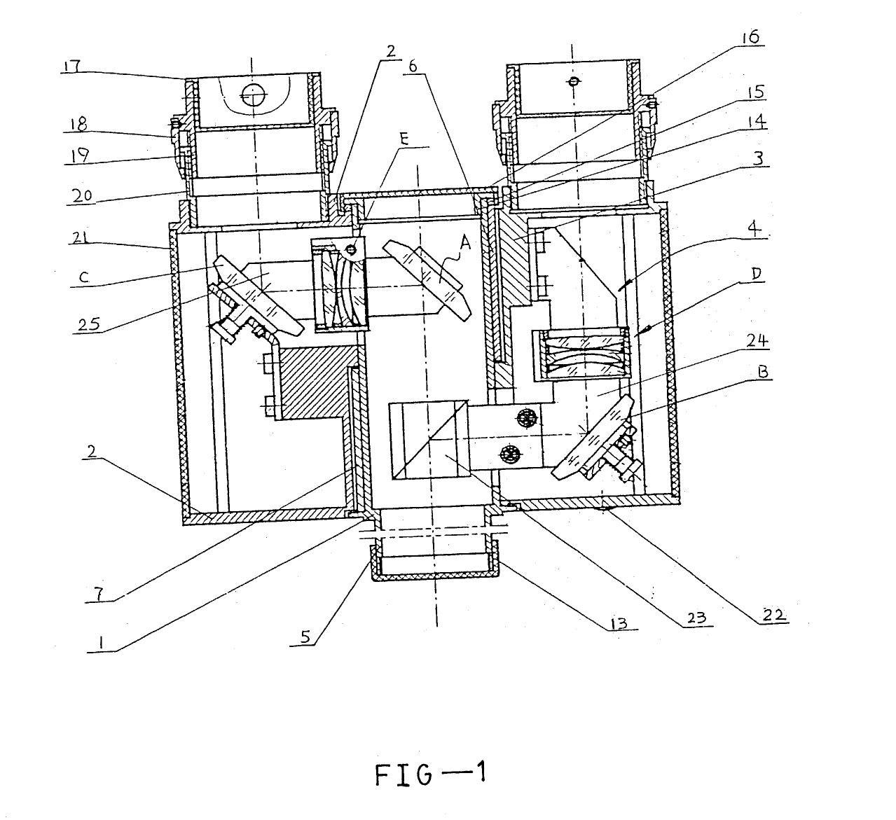

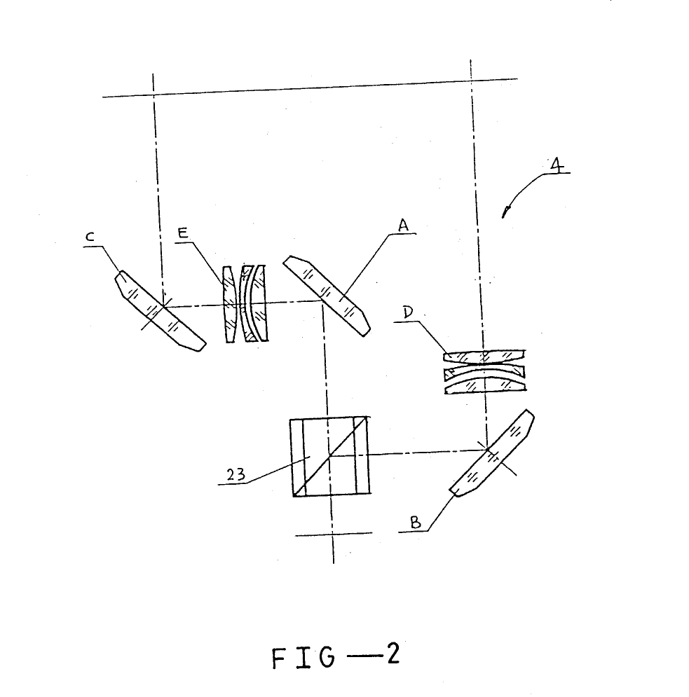

Please refer to the FIG. 1 and FIG. 2. As shown in the drawings, a binocular device comprises of a center tube 1, a left lens unit 2, a right lens unit 3, and a beam splitter and image-inverting device 4. The center tube 1 is shaped like a tube having a front section made as a joint 5 in a standard fitting size of φ31.75. The joint 5 is directly connected to an astronomical telescope (not shown in drawing), the joint 5 having a joint cap 13. Fitted to a rear section of the center tube 1 are a fixing screw ring, a wave washer 15 and an eye distance knob 16.

The right lens unit 3 is shaped as a tube having a front section on which is a sideways projected hinge unit 7 that is joined to the center tube 1. The left lens unit 4 is also shaped as a tube having a rear section on which is a sideways projected hinge unit 6 that is joined to the center tube 1. At one end of the tube's left and right lens units 2, 3, where close to the human eyes are fitted with an upper lid 17, a visibility adjust wheel 18, an eyepiece tube 19, multiple threads 20 and a lens cap 21. Turning of the graduated wheel 18 moves the eyepiece tube 19. On the right lens unit 3 is a cap 22 of a small hole.

The beam splitter and image-inverting device 4 comprises a laminated beam splitter prism 23, three reflected mirrors A, B, C and two lens sets D, E. Wherein, each the lens set D, E having three lenses respectively, the lens set D located between two reflected mirrors A and B, the lens set E located between two reflected mirrors B and C. The image magnification rate of each lens set is β=−1X.

The beam splitter prism 23 and the flat reflected mirror A are assembled inside the center tube 1. The flat reflected mirror A is located axially to the light beam which passing through the laminated beam splitter prism 23, the flat reflected mirror B and the lens set D are sequentially located in the right lens unit 3 and the reflected mirror B is installed axially to a split light beam from the laminated beam splitter prism 23, and the lens set D is installed on an axis of light beam which reflected from the reflected mirror B.

Furthermore, the beam splitter prism 23, the flat reflected lens B and the lens set D are assembled as an image unit and fixed by screw in the right lens unit 3 with a right support 24. The flat reflected mirror C and the lens set E installed on an axis of light beam reflected from the flat reflected mirror A are assembled with the beam splitter prism 23 to form another image unit and fixed by screw in the left lens unit 2 with a left support 25.

The working principle and main feature of the present invention lies in overlapping the images of the objective lenses of both the auxiliary binocular device and an astronomical telescope or an observation instrument. In other words, the light beam of image of the object being observed travels through the objective lens and the eyepiece of the astronomical telescope, the image observed is converted to an object of the auxiliary binocular device which is attached to the telescope. Then the light beam of object passing through the objective lens of the astronomical telescope and enters the auxiliary binocular device and reaches the beam splitter prism 23, the light beam is split into two light beams, one passing through the beam splitter prism 23, the other being reflected and projected out the beam splitter prism 23. By way of reflections and focusing through the reflected mirrors A, B, C and the lens sets D, E, the two light beams respectively form images on the front focus surface of the left and the right eyepieces, and enters the viewer's eyes through the binocular lenses.

A hinge mechanism joined to the center tube 1 serves to adjust the distance between the left lens unit 2 and the right lens unit 3, thereby the optical system on the left and right sides is rotated around the center tube 1 to adjust the distance between left and right lens units to suit two pupils of the observer.

To observe an object in a short distance, the user may rotate the focus adjustment wheel to change the focus. To suit different visions of the user's left and right eyes, this device is equipped with a vision hand wheel for adjustment. The binocular device is also designed different rate of magnification to change the magnifying rate of the original observing instrument.

Optionally, the lens focus of the invention is designed at f=39.6 mm, rate of magnification at β=−1X, visibility field at 12.3 mm, numerical aperture: 0.0633, range of eye-distance adjustment: 53˜75 mm, left/right vision tube adjustment axial distance 4.5 mm, to accommodate the installation of eyepieces with different focuses for necessary adjustment.

This device has solved problems in design and production of installing aberrations calibrated lens sets in a compact space, and the coating of beam splitter membranes with high requirements. The optical system's three flat reflected mirror in this binocular attaching device can also be designed with three sets and three pieces of prisms and lens sets. The entire optical system can also be designed in different rates of magnification to change the magnifying rate of the original observation instrument.

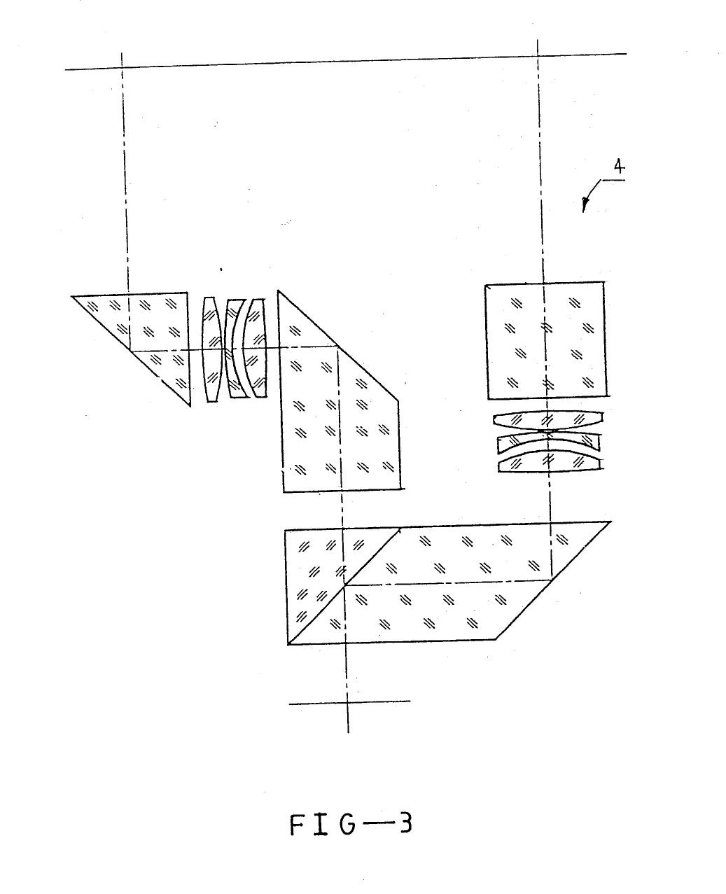

FIG. 3 shows optical reflections in a second embodiment. The three flat reflected mirrors are replaced by 3 prisms, while the left and right lens units are exactly the same, but it costs higher than the first embodiment which is more suitable for manufacture.

The present invention is an auxiliary device to an observation instrument, mainly applied to change an astronomical telescope into a binocular system, further, it can also be applied to other monocular observing instruments.

What is claimed is:

1. An auxiliary binocular device for astronomical telescope, comprising:
a center tube, shaped as a tube, having a front section serving as a joint for connection with an astronomical telescope;
a left lens unit, shaped as a tube, having an axis that is parallel to an axis of the center tube, and a sideways projected hinge unit that is joined to said center tube, at one end of the lens unit being an eyepiece;
a right lens unit, shaped as a tube, having an axis that is parallel to an axis of the center tube, and a sideways projected hinge unit that is joined to said center tube, at one end of the lens unit being an eyepiece;
a beam splitter and image-inverting device, comprising a beam splitter prism, three reflected mirror and two lens sets, wherein:
the beam splitter prism and the first reflected mirror are sequentially assembled inside the center tube, behind the joint of the center tube, and first reflected mirror being installed axially to the light beam which passing through the beam splitter prism;
the second reflected mirror and the first lens set are installed inside the right lens unit, on a light beam splitting axis of the beam splitter prism, said the beam splitter prism , and the second reflected mirror and the first lens set are assembled to form an image , the image unit is fixed by screw in the right lens unit with a support;
the third reflected mirror and the second lens set are installed on a light beam splitting axis of the first reflected mirror , the third reflected lens and the second lens set are assembled to form an image unit, the image unit is fixed by screw in the left lens unit with a support.

2. The auxiliary binocular device for astronomical telescope claimed in claim 1, wherein the second lens set is installed between the first reflected mirror and the third reflected mirror.

3. The auxiliary binocular device for astronomical telescope, claimed in claim 1, wherein all reflecting lenses are flat reflected mirrors, the image magnifying rate of the lens set β=−1X, the lens set being designed in three sets and three pieces.
